(19) United States
(12) Patent Application Publication
(10) Pub. No.: US 2023/0325948 A1
(43) Pub. Date: Oct. 12, 2023

(54) INTELLIGENT HOTEL BACKGROUND MONITORING SYSTEM CONVENIENT FOR WORK OF DISABLED PERSONS

(71) Applicant: Meng ZHAO, Zaozhuang (CN)

(72) Inventors: Meng ZHAO, Zaozhuang (CN); Yunjun ZHAO, Zaozhuang (CN); Jianling MAN, Zaozhuang (CN)

(73) Assignee: Meng ZHAO, Zaozhuang (CN)

(21) Appl. No.: 17/830,032

(22) Filed: Jun. 1, 2022

(30) Foreign Application Priority Data
Apr. 11, 2022 (CN) 202210375562.9

(51) Int. Cl. G06Q 50/12; H04N 5/76; G06Q 10/06

(52) U.S. Cl. CPC G06Q 50/12; H04N 5/76; G06Q 10/06316

(57) ABSTRACT

The present invention belongs to the technical field of hotel monitoring and management, particularly relates to an intelligent hotel background monitoring system convenient for work of disabled persons, comprising a hotel end and a client. The hotel end comprises a distribution unit. In the present invention, hotel end software is opened by managers, and the managers can use the distribution unit to distribute jobs to the disabled persons; and the disabled persons have a smart phone respectively in hands to view notification information. After seeing a room number, the disabled persons can know where the room is located.

### CROSS-REFERENCE TO RELATED APPLICATIONS

The application claims priority to Chinese patent application No. 202210375562.9, filed on Apr. 11, 2022, the entire contents of which are incorporated herein by reference.

### TECHNICAL FIELD

The present invention belongs to the technical field of hotel monitoring and management, particularly relates to an intelligent hotel background monitoring system convenient for work of disabled persons.

### BACKGROUND

With the continuous recovery and rapid development of the global economy, the development speed and the employment rate of the hotel industry in the world and in China will far exceed those of traditional industries. At present, the management level of hotels is generally in the form of a pyramid, which is from wide to narrow when from the bottom to the top of the tower. The higher the management range is, the larger the management difficulty is; the lower the management range is, the smaller the management difficulty is. The common hotel management in China is linear functional management system. In this management system, leaders, managers and waiters at any level shall clarify own business ranges, job responsibilities, as well as job skills and knowledge they should have.

At the same time, by 2020, the number of disabled persons in China is roughly 85 million, wherein 15 million disabled persons have living standards below the national level, and disabled persons are discriminate) in the actual employment process. Thus, the actual life of most disabled persons can only rely on social subsidies, and there are a series of problems such as the decline of the social status of the disabled persons and lack of respect. Therefore, it is very necessary to provide a simple job for the disabled persons and help the disabled persons to find jobs. At the same time, work such as hotel sanitation services is relatively simple, which is very beneficial to the disabled persons to engage in the work.

However, most of the current hotel sanitation management systems are mainly designed for normal persons, and cannot well help the disabled persons to work when applied to the disabled persons. Most of disabled persons are inconvenient in actions and speech communication. If a disabled person is commanded to go to a hotel room to clean, the disabled persons with action inconvenience need to spend more time to prepare, and it will take more time to communicate with the disabled persons with speech inconvenience, which is very unfavorable for hotel management. Therefore, it is also the main reason that most hotels are reluctant to accept the disabled persons currently.

In view of this, the present invention proposes an intelligent hotel background monitoring system convenient for work of disabled persons to solve the above technical problems.

### SUMMARY

In order to overcome the defects of the prior art and solve the technical problems of long preparation time and inconvenient communication when disabled persons clean hotels and influence on the cloning efficiency of hotel rooms, the pre sent invention proposes an intelligent hotel background monitoring system convenient for work of disabled persons.

To solve the technical problems, the present invention adopts the following technical solution:

An intelligent hotel background monitoring system convenient for work of disabled persons in the present invention comprises:
a hotel end, for managing how disabled persons perform hotel cleaning and improving the convenience for the disabled persons to clean rooms;
a client, for facilitating customers to check hotel situations and order hotel rooms;
a disabled person end, for the disabled persons to receive hotel room cleaning information;
a cloud server, for storing the data of the hotel end, the disabled person end and the client;
a distribution unit arranged in a hotel end program, which can intelligently distribute different disabled persons to different positions to perform work;
a storage unit, which is a sub-module of the distribution unit, used for managing appliances required for the work of the disabled persons;
a position unit, wherein the storage unit is a sub-module of the distribution unit and the position unit can confine the working positions of the disabled persons, and can help the disabled persons to quickly locate hotel rooms which need to be cleaned;
a cleaning unit, which is a sub-module of the distribution unit and is used to record detailed information in the process of cleaning the hotel rooms by the disabled persons.

Preferably, the position unit comprises:
a positioning module, wherein the positioning module belongs to a functional module of the position unit, and the positioning module is used for positioning the disabled persons;
a patrol inspection module, wherein the patrol inspection module belongs to a functional module of the position unit, and the patrol inspection module is used for hotel managers to inspect and record the cleaned rooms.

Preferably, a safety module is arranged in the disabled person end; the disabled persons have difficulties in action or speech; and once a dangerous situation is encountered, the disabled persons seek emergency help through the safety module.

Preferably, the cleaning unit comprises:
a recording component, wherein the recording component selects a smart phone or a two-way camera, and the recording component is used for recording the cleaning situations of the rooms when persons clean the hotel rooms, and allowing the hotel managers to check recording videos through the patrol inspection module;
an uploading module, which is used for uploading the videos recorded by the recording component to the cloud server through a network for storage.

Preferably, a monitoring unit sub-module is arranged in the distribution unit, and the monitoring unit is used for checking the working conditions of the disabled persons in the working process of the disabled persons to prevent the disabled persons from being unable to find obstacles in time.

Preferably, the client comprises:
an evaluation module, which can record the evaluation of customers for the rooms when the customers live in a hotel;
a room ordering module, which can provide a channel for the customers to order the hotel rooms.

Preferably, the room ordering module comprises two functional modules of “before check-in” and “after check-in”. Before and after a customer checks into the hotel, the room ordering module in the client presents two functional modes, which is convenient for the customer to place orders and check room details.

Preferably, the customer can view specific room types of the hotel rooms and the cleaning videos of the rooms through the room ordering module before checking into the hotel, wherein the cleaning videos are stored in the cloud server.

Preferably, after the customer checks into the hotel, the cleaning video in the room ordering module are automatically replaced with an exclusive video, and only the check-in customer is allowed to view the cleaning condition of the current room;

The room ordering module is provided with a residence feedback sub-module. The customers who have poor or good experience in a living process input living experience in the residence feedback sub-module, and feed back to the patrol inspection module in the hotel end through the evaluation module, so that the hotel managers can find and solve problems in time.

The present invention has the following beneficial effects:
1. In the intelligent hotel background monitoring system convenient for work of disabled persons in the present invention, hotel end software is opened by the managers, and the distribution unit in the software displays the states of all the disabled persons in charge of cleaning on the software, such as “working”, “resting” and “asking for leave”. At this time, the managers can select the same number of “resting” persons according to the number of rooms to be cleaned; and these disabled persons have a smart phone respectively in hands to view notification information. Then, a room number is displayed on the phones of the disabled persons. Therefore, the disabled persons only need to recognize numbers, and it is not mandatory to be literate, so as to prevent the condition that some disabled persons lack of knowledge. Thus, after seeing the room number, the disabled persons can know where the room is located, so that the managers do not need to communicate with the disabled persons, thereby solving the problem that some disabled persons have speech disorders and the clewing efficiency of the room is reduced because of communication inconvenience.
2. In the intelligent hotel background monitoring system convenient for work of disabled persons in the present invention, after the managers divide the work for the disabled persons through the distribution unit, the storage unit receives the information of the distribution unit synchronously. Each cleaning tool in a hotel warehouse has a separate number, and each separate number corresponds to a designated disabled person. Because each disabled person has different physical defects, if each disabled person uses the same tool, it is very inconvenient for the disabled persons to operate. Each tool is individually numbered so that the disabled persons can quickly find tools suitable for them when taking tools, thereby shortening the time for the disabled persons to prepare the tools.
3. In the intelligent hotel background monitoring system convenient for work of disabled persons in the present invention, after the disabled person cleans the room, the disabled person clicks a “completed” button on a room number notification interface of the smart phone to confirm that the room is cleaned. Then, the manager can check which rooms have been cleaned through the patrol inspection module, and then the manager arrives at a designated room for patrol inspection, and scores each cleaned room. Higher scores are given for rooms that are cleaned better, and then corresponding rewards are provided for relevant cleaning persons, so as to increase the income of the disabled persons, increase the cleaning enthusiasm of all the disabled persons and ensure that the sanitation of the hotel rooms meets the standards.

### BRIEF DESCRIPTION OF DRAWINGS

The present invention is further described below in combination with the drawings.

FIG. 1 is a structural block diagram of a system of the present invention;

FIG. 2 is a block diagram of a room ordering module of the present invention; and

FIG. 3 is a flow chart of operation of a patrol inspection module of the pre sent invention.

### DETAILED DESCRIPTION OF THE EMBODIMENTS

To easily understand the technical means, the creative feature, the purpose and the effect realized by the present invention, the present invention is further elaborated below in combination with specific embodiments.

Embodiments of the present invention provide an intelligent hotel background monitoring system convenient for work of disabled persons to solve the technical problems of long preparation time and inconvenient communication when the disabled persons clean hotels, and influence on the cleaning efficiency of the hotel rooms.

To solve the above technical problems, the technical solutions in the embodiments of the present invention have the following general idea; the distribution unit automatically assigns tasks for the disabled persons, and the storage unit organizes different tools for the disabled persons, so as to shorten the time for the disabled persons to prepare the tools; safety supervision and cleaning supervision for the disabled persons by the position unit and the cleaning unit ensure the safety of the disabled persons and the cleanliness of the hotel rooms. In addition, in this process, the number of communication between the managers and the disabled persons is very small, so that the disabled persons can know the positions of the rooms that need to be cleaned without the need of repeated communication with the disabled persons with speech disorders, thereby greatly improving the cleaning efficiency of the rooms.

To better understand the above technical solutions, the above technical solutions will be detailed below in combination with drawings of the description and specific implementation.

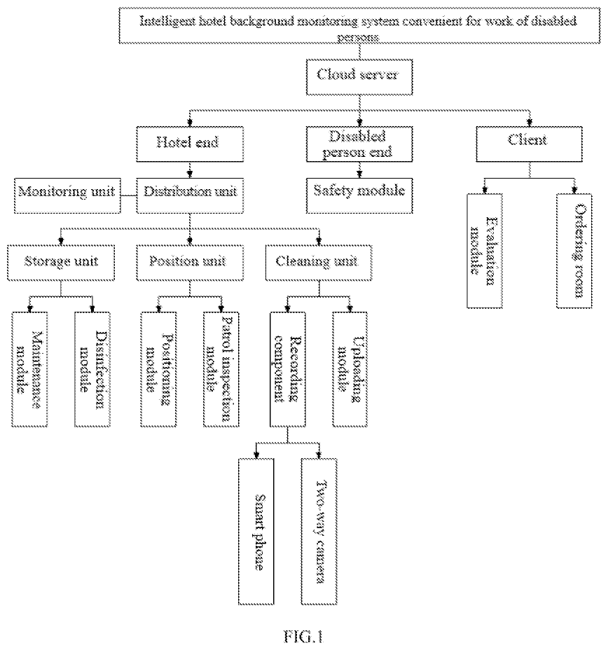

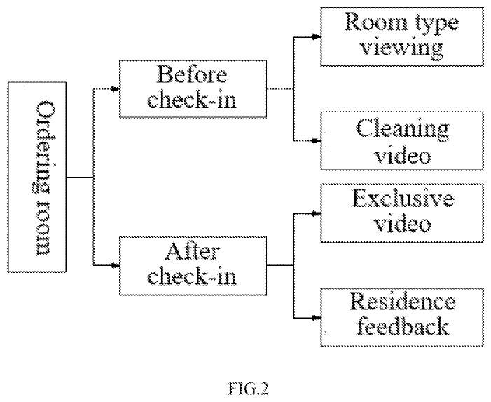

As shown in FIG. 1 to FIG. 3, the embodiments of the present invention provide an intelligent hotel background monitoring system convenient for work of disabled persons, comprising:
a hotel end, for managing how disabled persons perform hotel cleaning and improving the convenience for the disabled persons to clean rooms;
a client, for facilitating customers to check hotel situations and order hotel rooms;
a disabled person end, for the disabled persons to receive hotel room cleaning information;
a cloud server, for storing the data of the hotel end, the disabled person end and the client;
a distribution unit arranged in a hotel end program, which can intelligently distribute different disabled persons to different positions to perform work;
a storage unit, which is a sub-module of the distribution unit, used for managing appliances required for the work of the disabled persons;
a position unit, wherein the storage unit is a sub-module of the distribution unit and the position unit can confirm the working positions of the disabled persons, and can help the disabled persons to quickly locate hotel rooms which need to be cleaned;
a cleaning unit, which is a sub-module of the distribution unit and is used to record detailed information in the process of cleaning the hotel rooms by the disable d persons.

In the present embodiment, the hotel end and the client are operable software. The software can be arranged in a computer or in a smart phone. According to the needs of hotel managers and customers, the software can be installed on the computer or the smart phone freely. The operation on the computer end is basically the same as an operation method on a phone end. For example, a hotel manager uses a smart phone to install the software on the hotel end onto the smart phone, and enters a relevant account to log in the software. At the same time, the information of all disabled persons responsible for cleaning the hotel is stored in the cloud server. When a hotel room needs to be cleaned, the hotel manager starts the software at the hotel end, finds the distribution unit, and then clicks on a phone screen to enter. At this time, the distribution unit displays the states of all the disabled persons responsible for cleaning, such as “working”, “resting” and “asking for leave”. At this time, the manager can select the same number of “resting” persons according to the number of rooms that need to be cleaned, and these disabled persons have a smart phone respectively. Software at the disabled person end is installed in the smart phone, and is used for the disabled persons to view the notification information of cleaning of the hotel rooms. After the manager completes distribution of disabled persons, the position unit sends distribution information to the phone of the disabled person, so that only one room number and room position map are displayed on a phone interface of the disabled person to help the disabled person to quickly locate the hotel room that needs to be cleaned, so that the disabled person only needs to be able to recognize numbers, but not mandatory to be literate, thereby preventing some disabled persons from being illiterate due to lack of knowledge; and after hotel training, the disabled person can know where the room is after seeing the room number, and the disabled person can go to a hotel warehouse to choose appropriate cleaning tools. Thus, the manager does not need to communicate with the disabled person verbally, thereby solving the problem that some disabled persons have speech disorders and the cleaning efficiency of the room is reduced because of communication inconvenience.

After the managers divide the work for the disabled persons through the distribution unit, the storage unit receives the information of the distribution unit synchronously. Each cleaning tool in a hotel warehouse has a separate number, and each separate number corresponds to a designated disabled person. Because each disabled person has different physical defects, if each disabled person uses the same tool, it is very inconvenient for the disabled persons to operate. Each tool is individually numbered so that the disabled persons can quickly find tools suitable for them when taking tools, thereby shortening the time for the disabled persons to prepare the tools. At the same time, the cleaning tools need to be regularly maintained and sterilized to prevent the cleaning tools from carrying germs, etc., which will pollute the hotel rooms during cleaning. The manager needs to input the numbers of the cleaning tools under maintenance and disinfection into a maintenance module or a disinfection module in the storage unit for recording. Therefore, when the storage unit distributes the tools, the disabled persons can avoid these tools, to prevent the disabled persons from taking wrong tools and polluting the hotel moms.

Then, after the disabled person arrives at a designated room with a tool, the disabled person clicks an “arrived” button on the room number notification interface of the smart phone, and then the position unit feeds back the relevant information to a program at the hotel end, so that the manager knows that the disabled person has arrived at the designated position. At the same time, the manager can observe the cleaning situation of the disabled person through the cleaning unit, so as to prevent the disabled person from omitting in the cleaning process. The manager can directly send voice or picture tags to the phone of the disabled person through the cleaning unit, which is convenient for the disabled person in timely processing. Or, if the disabled person is in danger, the manager can find this situation in time to avoid the occurrence of casualties, thereby fully improving the safety of the disabled person in the cleaning process, and ensuring the cleanliness of the room, so that customers live in the room more pleasantly and comfortably.

As an embodiment of the present invention, as shown in FIG. 1, the position unit comprises:
a positioning module, wherein the positioning module belongs to a functional module of the position unit, and the positioning module is used for positioning the disabled persons;
a patrol inspection module, wherein the patrol inspection module belongs to a functional module of the position unit, and the patrol inspection module is used for hotel managers to inspect and record the cleaned moms.

A safety module is arranged in the disabled person end; because the disabled persons have difficulties in action or speech, once a dangerous situation is encountered, the disabled persons seek emergency help through the safety module.

After the disabled person arrives at the designated room, the disabled person clicks “arrived” on the room number notification interface of the smart phone. At this time, the “arrived” button is changed to a “completed” button, and then the position unit transmits an updated position in the positioning module into the software at the hotel end. Thus, the manager knows the position of the disabled person, and at the same time, the patrol inspection module records the information of the room to be cleaned by the disabled person. After the disabled person cleans the room, the disabled person clicks the “completed” button on the room number notification interface of the smart phone to confirm that the room is cleaned. Then, the manager can check which rooms have been cleaned through the patrol inspection module, and then the manager arrives at a designated room for patrol inspection, and scores each cleaned room. Higher scores are given for rooms that are cleaned better, and then corresponding rewards are provided for relevant cleaning persons, so as to increase the income of the disabled persons, increase the cleaning enthusiasm of all the disabled persons and ensure that the sanitation of the hotel rooms meets the standards.

Because the disabled persons are more vulnerable than normal persons, once there are some accidents in the cleaning process, the disabled persons may not be able to call for help in time. At this time, the disabled person can trigger a safety alarm through the room number notification interface of the smart phone by long-pressing a room number. As shown in FIG. 1, the safety module in the disabled person end is started, and then sends information to the hotel end, so that the smart phone of the manager generates an alarm sound. Then, the manager can quickly find the position of the disabled person through the position intimation, provided by the position unit, of the disabled person and provide assistance in time.

As an embodiment of the present invention, as shown in FIG. 1, the cleaning unit comprises:
a recording component, wherein the recording component selects a smart phone or a two-way camera, and the recording component is used for recording the cleaning situations of the rooms when persons clean the hotel rooms, and allowing the hotel managers to check recording videos through the patrol inspection module;
an uploading module, which is used for uploading the videos recorded by the recording component to the cloud server through a network for storage.

A monitoring unit sub-module is arranged in the distribution unit, and the monitoring unit is used for checking the working conditions of the disabled persons in the working process of the disabled persons to prevent the disabled persons from being unable to find obstacles in time.

When the disabled person is cleaning the room, the disabled person starts a shooting function of the smart phone, so that when the person is cleaning, the smart phone can shoot the cleaning position of the disabled person in real time. Some disabled persons cannot operate smart phones, and can choose to shoot with a two-way camera to ensure that the cleaning videos can be recorded completely, and this part of disabled persons still has a smart phone. When the smart phone is only used for the disabled persons to check the position of the room number and related confirmation operation, i.e., some simple operations, the disabled persons with insufficient knowledge can also operate.

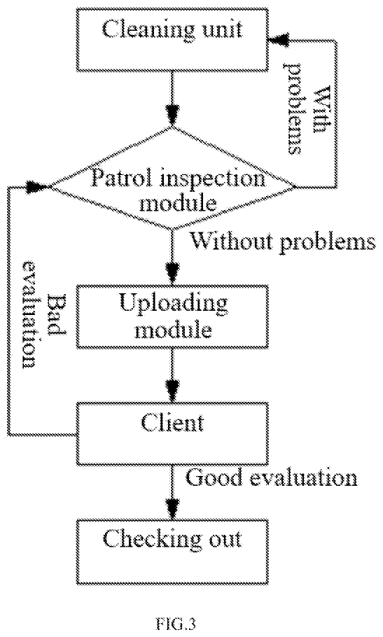

After the cleaning is completed, the recorded videos in the smart phone are automatically sent to the uploading module of the hotel end through a network, and the videos recorded by the two-way camera are manually uploaded by the manager. After uploading the videos, when the manager conducts patrol inspection for the room, the manager inspects the cleaning videos to inspect whether there are irregularities in the process of cleaning the room by the disabled person, and whether there is a place which is not cleaned. As shown in FIG. 3, if the manager finds a problem, the relevant problem is fed back to the cleaning unit, so that the disabled person can view the relevant information through the smart phone in hands, and the displayed room number information is displayed in “red”, indicating that the disabled person needs to bring tools to clean the corresponding rooms again to solve the problem. Conversely, if the manager does not find any problem in the patrol inspection process, the video in the uploading module is renamed and written with “room number+accepted”. Then, the video is uploaded to the cloud server through the uploading module, so that customers can check the cleaning videos of the relevant rooms when using the client. Thus, the customers can live with more confidence.

Some disabled persons may be in wheelchairs, lack of arms, etc. These disabled persons can observe computer programs at the hotel end, observe the interior of the hotel through the cameras of the hotel and can also observe the working conditions of the disabled persons to prevent the disabled persons from being undiscovered in time when in obstacles. Such monitoring work is simple and has few operation steps, which is also conducive to the work of the disabled persons, thereby solving the problem of difficult employment of the disabled persons.

As an embodiment of the present invention, as shown in FIG. 1, the client comprises:
an evaluation module, which can record the evaluation of customers for the rooms when the customers live in a hotel;
a room ordering module, which can provide a channel for the customers to order the hotel rooms.

The room ordering module comprises two functional modules of “before check-in” and “after check-in”. Before and after a customer cheeks into the hotel, the room ordering module in the client presents two functional modes, which is convenient for the customer to place orders and check room details.

The customer can view specific room types of the hotel rooms and the cleaning videos of the rooms through the room ordering module before checking into the hotel, wherein the cleaning videos are stored in the cloud server.

After the customer checks into the hotel, the cleaning video in the room ordering module are automatically replaced with an exclusive video, and only the check-in customer is allowed to view the cleaning condition of the current room;

The room ordering module is provided with a residence feedback sub-module. The customers who have poor or good experience in a living process can input living experience in the residence feedback sub-module, and can feed back to the patrol inspection module in the hotel end through the evaluation module, so that the hotel managers can find and solve problems in time.

When a customer needs to live in a hotel, the customer can subscribe through a client APP on the smart phone. In the client software, the customer can click on a relevant room when selecting a room, and then the client will pop up a new window, so that the customer can click a corresponding option to view a room type to enhance the experience of the customer. At the same time, the customer can also view the cleaning video of the room, wherein the cleaning video is obtained from the cloud server, so as to reduce the worry of the customer. After the existing hotel is cleaned, the customer does not know which articles in the room are cleaned, such as teakettles in the room. Other customers probably add sundries to the teakettles. With the statements on the Internet, the customers living in the hotel do not use the teakettle or may make corresponding complaints when observing that the teakettle is not clean. Therefore, when the customers see that the cleaning persons clean the teakettles in the room, the customers dare to use the teakettles when living later, so that the customers can drink clean and hygienic hot water in the room, thereby improving the experience of the customers.

After the customer checks in a room, the corresponding room is hidden in the client software, so that other customers cannot order this room. In order to ensure the living experience of the customer, the room to be continuously ordered is routinely cleaned every day. At this time, the customer can view the exclusive cleaning video of the room through the client, so that the daily cleaning video of the room can only be viewed by the continuing customer. The hotel manager or other customers who do not check in the room cannot view the cleaning video of the room, so as to fully protect the privacy of the customer, so that the continuing customer confirms whether the room is cleaned thoroughly according to the exclusive video and confirms whether the cleaning person has done bad behaviors in the room, so that the living environment of the customer is always kept good, and the customer also feels more relieved during the living process.

In the overstaying process of the customer, due to lack of patrol inspection by the manager, the manager cannot find out a position not cleaned thoroughly in time. At this time, the customer can feed back the corresponding information through a residence feedback module in the client. The relevant feedback information is sent to the cloud server through the evaluation module, and then is transferred to the hotel end through the cloud server, so that the manager can know the needs of the customer in time, and then assign a disabled person to a designated room to clean through the distribution unit. In this process, the manager does not need to communicate with the disabled person directly. The disabled person can know the room to be cleaned according to the information received, thereby improving the cleaning efficiency of the hotel.

After the customer leaves the hotel, the customer can write the evaluation in the evaluation module of the client, so that other customers have more tendency to place orders after observing the evaluation, which ensures that the occupancy rate of the hotel is increased. The evaluation contents of the customer are saved in the cloud server, as shown in FIG. 3. If the evaluation of the customer is good, the manager will not do anything; otherwise, if the evaluation of the customer is not good, the relevant negative comment is sent from the cloud server to the patrol inspection module of the position unit. Then, the manager checks the relevant bad evaluation, goes to a designated room for viewing according to the problems pointed out by the customer, and designates the relevant persons for processing through the distribution unit. After processing, relevant processing photos are sent below the comment. Thus, when other customers check the evaluation, according to the rectification of the hotel, customer satisfaction to the hotel can be improved.

The specific workflow is us follows:

When a hotel room needs to be cleaned, the hotel manager starts the software at the hotel end, finds the distribution unit, and then clicks on the phone screen to enter. At this time, the distribution unit displays the states of all disabled persons responsible for cleaning on the screen. At this time, the manager can select the same number of persons according to the number of rooms to be cleaned, and these disabled persons have a smart phone respectively in hands to view the notification information. Therefore, a room number is displayed on the phone of the disabled person, so that the disabled person can know position where the room is located after seeing the room number. At the same time, each cleaning tool in the hotel warehouse has a separate number, and each separate number corresponds to one designated disabled person. Because each disabled person has different physical defects, if each disabled person uses the same tool, it is very inconvenient for the disabled persons to operate. Each tool is individually numbered so that the disabled persons can quickly find tools suitable for them when taking tools, thereby shortening the time for the disabled persons to prepare the tools. Then, after the disabled person arrives at a designated room with a tool, the disabled person clicks an “arrived” button on the room number notification interface of the smart phone, and then the position unit feeds back the relevant information to a program at the hotel end, so that the manager knows that the disabled person has arrived at the designated position and then the disabled person starts to clean the room.

The above shows and describes the basic principle, main features and advantages of the present invention. Those skilled in the art shall understand that the present invention is not limited by the above embodiment. The above embodiment and the description merely illustrate the principle of the present invention. Various changes and improvements can also be made to the present invention without departing from the spirit and scope of the present invention, and shall fall into the protection scope of the present invention. The protection scope of the present invention is defined by the appended claims and equivalents.

What is claimed is:

1. An intelligent hotel background monitoring system convenient for work of disabled persons, comprising:
a hotel end, for managing how disabled persons perform hotel cleaning and improving the convenience for the disabled persons to clean rooms;
a client, for facilitating customers to check hotel situations and order hotel rooms;
a disabled person end, for the disabled persons to receive hotel room cleaning information;
a cloud server, for storing the data of the hotel end, the disabled person end and the client;
a distribution unit arranged in a hotel end program, which can intelligently distribute different disabled persons to different positions to perform work;
a storage unit, which is a sub-module of the distribution unit, used for managing appliances required for the work of the disabled persons;
a position unit, wherein the storage unit is a sub-module of the distribution unit and the position unit can confirm the working positions of the disabled persons, and can help the disabled persons to quickly locate hotel rooms which need to be cleaned;
a cleaning unit, which is a sub-module of the distribution unit and is used to record detailed information in the process of cleaning the hotel rooms by the disabled persons.

2. The intelligent hotel background monitoring system convenient for work of disabled persons according to claim 1, wherein the position unit comprises:
a positioning module, wherein the positioning module belongs to a functional module of the position unit, and the positioning module is used for positioning the disabled persons;
a patrol inspection module, wherein the patrol inspection module belongs to a functional module of the position unit, and the patrol inspection module is used for hotel managers to inspect and record the cleaned rooms.

3. The intelligent hotel background monitoring system convenient for work of disabled persons according to claim 1, wherein a safety module is arranged in the disabled person end; because the disabled persons have difficulties in action or speech, once a dangerous situation is encountered, the disabled persons seek emergency help through the safety module.

4. The intelligent hotel background monitoring system convenient for work of disabled persons according to claim 1, wherein the cleaning unit comprises:
a recording component, wherein the recording component selects a smart phone or a two-way camera, and the recording component is used for recording the cleaning situations of the rooms when persons clean the hotel rooms, and allowing the hotel managers to check recording videos through the patrol inspection module;
an uploading module, which is used for uploading the videos recorded by the recording component to the cloud server through a network for storage.

5. The intelligent hotel background monitoring system convenient for work of disabled persons according to claim 1, wherein a monitoring unit sub-module is arranged in the distribution unit, and the monitoring unit is used for checking the working conditions of the disabled persons in the working process of the disabled persons to prevent the disabled persons from being unable to find obstacles in time.

6. The intelligent hotel background monitoring system convenient for work of disabled persons according to claim 1, wherein the client comprises:
an evaluation module, which can record the evaluation of customers for the rooms when the customers live in a hotel;
a room ordering module, which can provide a channel for the customers to order the hotel rooms.

7. The intelligent hotel background monitoring system convenient for work of disabled persons according to claim 6, wherein the room ordering module comprises two functional modules of “before check-in” and “after check-in”, before and after a customer checks into the hotel, the room ordering module in the client presents two functional modes, which is convenient for the customer to place orders and check room details.

8. The intelligent hotel background monitoring system convenient for work of disabled persons according to claim 7, wherein the customer can view specific room types of the hotel rooms and the cleaning videos of the rooms through the room ordering module before checking into the hotel, wherein the cleaning videos are stored in the cloud server.

9. The intelligent hotel background monitoring system convenient for work of disabled persons according to claim 7, wherein after the customer checks into the hotel, the cleaning video in the room ordering module are automatically replaced with an exclusive video, and only the check-in customer is allowed to view the cleaning condition of the current room.

10. The intelligent hotel background monitoring system convenient for work of disabled persons according to claim 6, wherein the room ordering module is provided with a residence feedback sub-module, the customers who have poor or good experience in a living process input living experience in the residence feedback sub-module, and feed back to the patrol inspection module in the hotel end through the evaluation module, so that the hotel managers can find and solve problems in time.
